(19) United States
(12) Patent Application Publication
(10) Pub. No.: US 2006/0167140 A1
(43) Pub. Date: Jul. 27, 2006

(54) Curable Polyester Resin Compositions

(75) Inventors: Georges N. Altounian, Rochester, MN (US); Robert G. Jennison, Rochester, MN (US)

Correspondence Address: FOLEY & LARDNER LLP, 777 EAST WISCONSIN AVENUE, SUITE 3800, MILWAUKEE, WI, 53202-5308, US

(73) Assignee: McNeilus Truck and Manufacturing, Inc.

(21) Appl. No.: 11/275,290

(22) Filed: Dec. 21, 2005

Related U.S. Application Data
(60) Provisional application No. 60/638,095, filed on Dec. 21, 2004.
(60) Provisional application No. 60/638,845, filed on Dec. 23, 2004.

(51) Int. Cl. C08L 67/06

(52) U.S. Cl. 523/515; 523/523

(57) ABSTRACT

Curable polyester resins are described herein which may be used in a wide variety of fields. The curable polyester resins may include a curing accelerator such as DMAA, a rubber modifier such as polyvinyl acetate based material, and/or a copper salt.

### BACKGROUND

Curable organic polymeric resin compositions have been known for a number of years. These resins may be used as the continuous matrix in composite applications, in the fabrication of molded components, laminates, etc. In many situations, these resins are used in conjunction with a support or reinforcing structure such as fiberglass, etc. Unfortunately, curing many presently available resins results in the cured resin distorting and/or shrinking to a degree that micro cracks are formed. The cracking problem may be especially acute when these resins are used to make resin rich, thick, or complex designs in large molded components and/or used with more than one type of support structure.

Accordingly, it would be desirable to provide a curable resin composition that cures in a manner to provide reduced distortion and cracking of the cured resin, thus increasing the strength and utility of the resulting cured resin and facilitating the manufacture of complex design structures.

### SUMMARY

A curable resin composition is described herein which comprises an unsaturated polyester resin and a promoter system which is capable of reducing the cross link density of the polyester resin and is also capable of being cured at a commercially acceptable rate. In one embodiment, the promoter system includes an exothermic suppressant which is used to reduce the cross link density and a curing accelerator which accelerates the speed at which cross linking occurs without also increasing the cross link density of the cured resin. The use of this promoter system allows the curable resin composition to cure in a commercially acceptable amount of time and also reduce the cross link density which results in less shrinkage and/or distortion when the resin cures.

In one embodiment, the curing accelerator in the promoter system may include an N,N-disubstitutedacylacetamide having the following formula: 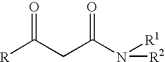
wherein R, R¹, R² are alkyl or aralkyl.

One example of a suitable compound is N,N-dimethylacetoacetamide. In addition, dimethylacetamide, diethylacetamide, etc., or mixtures thereof may also be used as the accelerator. The accelerators may also include organic salts of cobalt, vanadium, calcium, or mixtures thereof. Initiators that may be used in the promoter system include peroxides such as methyl ethyl ketone peroxide (MEKP), cumene hydroperoxide, methyl isobutyl ketone peroxide, etc., or mixtures thereof.

The promoter system may include organic copper salts such as copper naphthenate and/or copper octoate as the exothermic suppressant. The promoter system may also include other exothermic suppressant agents that are slow reacting cross linking agents such as alphamethyl styrene. The curable resin composition may also include reactive low profile additives or rubber modifiers. The rubber modifier may include oligomers and/or polymers which are polar such as polyvinyl acetate (PVAc) and polyvinyl alcohol and polar functionalized oligomers and/or polymers such as hydroxy, acid, or amine functionalized poly styrene-isoprene-styrene (SIS), poly styrene-butadiene-styrene (SBS), or polybutadiene, or any other suitable polar oligomers. The average MW of the oligomers may be about 200 to 12000, desirably, about 1000 to 8000, or, suitably, about 1500 to 6000.

The curable resin composition may also include cross linking monomers such as styrene, methylmethacrylate, methylacrylate, trimethylolpropane triacrylate, trimethylolpropanetrimethacrylate and others. These monomers may help develop the mechanical properties of the cured resin. In one embodiment, the average molecular weight (MW) of the unsaturated polyester resin may be about 1000 to about 12000, desirably about 1500 to about 10000, or, suitably, about 2000 to about 6000.

In one embodiment, the curable resin composition may be used to prepare a cured resin/support structure combination where the cured resin is at least substantially devoid of cracks. In a further embodiment, the curable resin composition may be used to prepare a cured resin/support structure combination where the cured resin is devoid of cracks. In another embodiment, the curable resin composition may have a ratio of the combination of unsaturated polyester resin and monomer(s) to rubber modified oligomers of between about 60/40 to about 97/3, or desirably between about 75/25 and about 95/5. In another embodiment, the curable resin composition may have a ratio of the combination of unsaturated polyester resin and monomers to rubber modified oligomers of at least about 60/40, desirably, at least about 70/30, or, suitably, at least about 80/20, or further suitably, about 90/10. The curable resin composition may have a ratio of unsaturated polyester resin to monomers of no more than about 85/25, desirably, no more than about 65/5, or suitably no more than about 60/40. In yet another embodiment, the cured resin may be made from only the unsaturated polyester resin without any additional rubber modifier.

A method for curing the resin composition may comprise contacting the resin composition with a catalytic amount of the initiator and optionally contacting the mixture with a reinforcing structure, and allowing the mixture to cure under conditions such that the peak exotherm is from about 200° F. to about 360° F. (1.25 inches thickness), the cure time is from about 5 to about 45 minutes, and the glass transition temperature of the cured resin is below the in-mold peak exotherm temperature. Also, in one embodiment, the glass transition temperature (Tg) is maintained near the heat of reaction for the curable resin composition.

The cured resin may be used to form any of a number of suitable molded, laminated, coated, or cast components in a number of industries such as automobile manufacturing, heavy duty vehicle manufacturing, etc. In one embodiment, the cured resin may be used with support structure materials such as fiberglass, metal, etc. that have different coefficients of thermal expansion. The cured resin has sufficient resiliency and strength to allow the two materials to expand at different rates without cracking or otherwise weakening the cured resin. It should be noted that all percents are provided herein as weight percent, unless noted otherwise.

### DRAWINGS

FIG. 1 shows a side view of a concrete vehicle.

FIG. 2 shows a top perspective view of a mixing drum of a concrete vehicle.

FIGS. 3-5 show various views of different embodiments of a drive ring that may be used to rotate the mixing drum of a concrete vehicle.

FIGS. 6-7 show perspective views of another embodiment of a drive ring that may be used to rotate the mixing drum of a concrete vehicle.

FIGS. 8-9 show perspective views of a drive ring that has glass reinforcing fiber woven around the teeth of the drive ring.

FIG. 10 shows a perspective view of the drive ring from FIGS. 8-9 with a curable resin composition molded to the portion of the drive ring that includes the teeth.

FIG. 11 shows a perspective view of one embodiment of a reinforced cured resin material after being subjected to an impact force under 21 J.

FIG. 12 shows a perspective view of one embodiment of a reinforced cured resin material after being subjected to an impact force above 21 J.

FIG. 13 shows a perspective view of one embodiment of a reinforced cured resin material after being subjected to an impact force under 1.4 J.

FIG. 14 shows a perspective view of one embodiment of a reinforced cured resin material after being subjected to an impact force above 1.4 J.

### DETAILED DESCRIPTION

The curable resin composition and method for curing such curable resin composition described herein may allow for the preparation of cured resins that are able to expand and contract with negligible internal stress and still have substantial strength. Because the cured resins are able to expand and contract in this manner, they do not exhibit cracking that is often present in currently available cured resins. These curable resin compositions may be particularly useful to prepare large parts having thick areas of cured resin that may otherwise cause the cured resins to crack during curing. The increased strength and the ability of the cured resins to expand and contract with very little stress may be attributable, at least in part, to lower amounts of shrinkage and/or distortion that the curable resin compositions experience compared to currently available technology during the curing process.

The curable resin compositions described herein generally include an unsaturated polyester resin and a promoter system. Suitable unsaturated polyester resins include vinyl esters that are epoxy ester resins. These may be formed by the reaction of bisphenol A with epichlorohydrin, which is further reacted with an unsaturated monocarboxylic acid such as methacrylic acid. Suitable unsaturated polyester resins include any of a number of conventional unsaturated polyester resins which are typically used for molding, laminating, spraying, and/or gel coating, including those which are prepared by polycondensation of polycarboxylic acid derivatives, one of which is an ethylenically unsaturated polycarboxylate, and polyhydric alcohols. Suitable polycarboxylic acid derivatives include polycarboxylic acids, their esters of lower alcohols, their amides, their acid chlorides, and their anhydrides.

The polycarboxylic acid and the polyhydric alcohols are usually reacted at 1:1 molar ratio. However, in many esterification processes, a slight excess of polyhydric alcohols is utilized to compensate for alcohol losses during esterification. Also, although dicarboxylic acids and dihydric alcohols are most frequently utilized and the 1:1 molar ratio is prevalent, polyhdric alcohols (triols, tetrols, etc.) may also be used. In this situation, one equivalent of acid is provided per equivalent of polyhydric alcohol.

Polyhydric alcohols which may be used to prepare unsaturated polyester resins include polyfunctional alcohols of the type conventionally utilized in polyester preparation. Such polyhydric alcohols include ethylene glycol, 1,5-propanediol, propylene glycol, triethylene glycol, butylene glycol, glycerol, diethylene glycol, 1,4,6-hexanetriol, cyclohexane dimethanol, trimethylolpropane, trimethylolethane, dipropylene glycol, pentaerythritol, neopentyl glycol, alkoxylated 2,2-bis(4-hydroxyphenyl)propane and the like. Although diols are generally desired in the preparation of unsaturated polyesters, more highly functional polyols, i.e., polyols having a functionality of three to five, are sometimes used.

The amount of unsaturated polyester resin included in the curable resin compositions may be between about 40% to about 90% based on the total weight of the composition, desirably, between about 70% to about 85%, or, suitably, between about 75% and 80%. In another embodiment the amount of unsaturated polyester resin included in the resin compositions may be between about 55% and 65%. In other embodiments, the amount of unsaturated polyester resin included in the curable resin composition is at least about 60%, 65%, 70%, 75%, 80%, or 90%. Also the average MW of the unsaturated polyester resin material may be about 1000 to about 12000, desirably about 1500 to about 10000, or, suitably, about 2000 to about 6000.

In some embodiments, the unsaturated polyester resin may be cross linked together without the use of other monomers and/or rubber modified oligomers. However, in many situations one or more additional monomers and/or oligomers may be used to cross link the unsaturated polyester resin. The average MW of the monomer composition used in the curable resin composition may be about 80 to 400, or desirably, about 86 to 339. The average MW of the rubber modified oligomers may be about 200 to 12000, desirably, about 1000 to 8000, or, suitably, about 1500 to 6000. It is believed that the difference in chain size between the monomers and the unsaturated polyester resin and the oligomers and the unsaturated polyester resin contributes to the amount of shrinkage and/or distortion that occurs when the curable resin composition cures.

The rubber modifier material may include any of a number of suitable oligomers which are capable of polymerizing with the unsaturated polyester resins. In one embodiment, the oligomers may be polar unsaturated oligomers. Suitable oligomers include ethylenically unsaturated and/or polar oligomers such as polyvinyl acetate (PVAc), polyvinyl alcohol, and/or polar functionalized oligomers such as hydroxy, acid, or amine functionalized (PVAc) poly styrene-isoprene-styrene (SIS), poly styrene-butadiene-styrene (SBS), polybutadiene, polystyrene, polymethylmethacrylate or any other suitable functionalized oligomers. Although not wishing to be bound by theory, it is believed that at least part of the reason that the cured resins described herein exhibit the desirable properties that they do is because the rubber modifier material and the polyester chains form distinct phases in the cured resin, thus combining the physical characteristics of the rubber modifier and the polyester resin. The oligomers have lower glass transition temperatures than the unsaturated polyester resin and thus contribute to the ability of the cured resins to expand and contract (rubbery phase) while the polyester chains provide the strength and toughness. The effect of the separate phases in the cured resin is believed to be more favorable than the effect a single phase system would provide. In other words, the desirable physical characteristics of the oligomer and the polyester resin alone may be diluted significantly if there was only a single phase system. That being said, it is believed that a multi-crysallographic phase cured resin produced as described herein may provide advantages over various previous cured resins.

It is generally desirable to use polar oligomers and/or polymers in the rubber modifier material because it is miscible with the unsaturated polyester resin before the reaction takes place. Thus, the rubber modifier may be easily mixed and reacted with the unsaturated polyester resin. The rubber modifier may include any of a number of oligomers and/or polymers that are polar or may be functionalized to be polar. For example, polyvinyl acetate, polyvinyl alcohols, etc. may be used as well as functionalized polyolefins with hydroxyl, acid, or amine groups. Some of the polyolefins may be polymer derivatives of dicyclopentadiene, alphaolefins, SIS, SBS, polybutadiene, and so on. Although the rubber modifier is miscible with the unsaturated polyester resin before reacting, it is generally desirable to have at least a portion of the rubber modifiers form polymer chains that are sufficiently incompatible with the polyester chains in the cured resin so as to form the previously mentioned multiple phases.

In addition to being polar, it may be desirable to use an oligomer that has a relatively low glass transition temperature (Tg). Using a monomer with a low Tg, serves to lower the Tg of the cured resin. Lowering the Tg of the cured resin so that it is closer to the peak exotherm temperature, provides the resin with additional resiliency while the resin cures. Because the Tg of the resin is closer to the temperature of the peak exotherm, the resin tends to be more “rubbery” or flexible at the temperature that it cools. Thus, distortions that may occur as the resin cures, especially when the resin is used in conjunction with a reinforcing structure (e.g., fiberglass, metal, etc.), and shrinks are absorbed by the increased ability of the resin to flex, thus reducing or preventing the formation of micro cracks. The oligomers referenced above have suitable Tg temperatures to provide the cured resin described herein. In one embodiment, the oligomer has a Tg of at least about −148° F. or at least about −58° F. The oligomer may also have a Tg of no more than about 158° F. or no more than about 32° F.

The oligomer component may be about 45% to 0% of the curable resin composition, desirably about 30% to about 5%, or suitably about 20% to about 7.5%. The monomer composition of the curable resin composition may be at least about 45%, 25%, 15%, 10% or 5%. Also the ratio of the combination of unsaturated polyester resin and monomers to oligomers is at least about 60/40, desirably, at least about 70/30, suitably, at least about 80/20, or further suitably, about 90/10.

The curable resin composition may include a promoter system that includes an exothermic suppressant and a curing accelerator. In general, the exothermic suppressant is used to decrease the cross link density of the cured resin. Decreasing the cross link density of the cured resin may, at least in part, act to provide some of the desirable properties such as flexibility and strength of the cured resin. The exothermic suppressant may be an organic copper salt. Suitable organic copper salts include copper salts of organic acids, desirably, salts of carboxylic acids. For example, copper salts of 6-20 carbon atom carboxylic acids or, desirably, 8-16 carbon atom carboxylic acids may be used. In one embodiment, the carboxylic acids are octanoic acid and naphthenoic acid. The copper salt may be used in a sufficient amount to control the peak exotherm to a level of from about 200° F. to about 360° F., desirably, 240° F. to 310° F., or, suitably, 265° F. to 300° F. for a 100 g mass (1.25 inches thick) of curable resin composition.

The copper salt may be present in the curable resin composition at a level of at least about 2 ppm, desirably, at least about 10 ppm, suitably, at least 100 ppm, or even more suitably, at least about 200 ppm. The copper salt may be present in an amount of no more than 1000 ppm, desirably, no more than 600 ppm, and, suitably, no more than 500 ppm.

In addition to the copper salt, the promoter system may include a curing accelerator. The use of the exothermic suppressant may extend the reaction time beyond what is commercially viable since, in general, the exothermic suppressant slows down the reaction rate. The curing accelerator may be used to speed up the rate at which reaction occurs. Curing accelerators that are widely used presently, dimethyl aniline and diethyl aniline also act to increase the peak exotherm and consequently increase the cross link density of the cured resin, thus negating the effect of the exothermic suppressant. Accordingly, in one embodiment, it may be desirable to use a curing accelerator which does not substantially affect the peak exotherm but does speed up the rate of reaction. Thus, a curing accelerator of this type results in the curable resin composition being curable in a commercially acceptable amount of time without increasing the cross link density of the cured resin. Examples of suitable accelerators include N,N-dimethylacetoacetamide, dimethylacetamide, diethylacetamide, N-phenyldiethanol amines, N-methyldiethanol amines, ethylacetoacetamide, methylacetoacetamide, 2,6-dimethyl acetanilide, etc., or mixtures thereof.

Additional accelerators may also be used to speed up the reaction. Such accelerators may be transition metal salts and more preferably salts of organic acids. Suitable transition metals include cobalt and vanadium, with cobalt being used most often. These metal salts tend to have a direct effect on the heat of reaction because they help initiate free radical polymerization. In one embodiment the accelerator may include cobalt salts of carboxylic acids having 2-20 carbon atoms or, desirably, cobalt salts of carboxylic acids having 8-16 carbon atoms. In particular, cobalt naphthenate and cobalt octoate may be used. The transition metal salts are present in a sufficient amount to provide a transition metal concentration which accelerates the break down of the peroxide initiator. The transition metal salts are preferably present in amounts of 30 parts per million by weight or greater, and more preferably 200 parts per million by weight or greater. The transition metal salt accelerators are preferably present in an amount of no more than 5000 ppm, or, desirably, no more than 2000-4000 ppm. The accelerators may be present in an amount of at least about 200 ppm, 1000 ppm, or, suitably, 3000 ppm.

The initiator may include any of a number of suitable compositions which are suitable to initiate polymerization of the unsaturated polyester resin. Suitable initiators include organic peroxides such as ketone peroxides, dioxyalkyl peroxides and diacyl peroxides. Examples of initiators include benzoyl peroxide, lauryl peroxide, t-butyl hydroperoxide, t-butyl perbenzoate, methyl ethyl ketone peroxide, methylisobutylketone peroxide, cyclohexanone peroxide, t-butyl peroxy benzoate, dibenzoyl peroxide, and cumene hydroperoxide. The initiator is present in an amount which allows the resin to react or polymerize at ambient temperatures. The initiator may be provided in an amount of at least about 0.1 pph (parts per hundred), desirably, at least about 0.5 pph, or, suitably, at least about 1 pph of the curable resin composition. The initiator may be provided in an amount of no more than 3 pph, desirably, no more than 2 pph, or, suitably, no more than 1 pph.

In addition to the components referenced herein, the curable resin composition may include small but effective quantities of thixotropic agents such as fumed silica and modified fumed silica, carboxy cellulose; pigments; and inert fillers such as silica, calcium carbonate, titanium dioxide, alumina trihydrate, clay, and/or magnesium oxide. As already mentioned, numerous types of reinforcing materials may be used including fibrous reinforcing material such as randomly or ordered glass fibers, woven glass fabrics, aramid fibers, carbon fibers, polyester fibers, acrylic fibers, milled fibers, metals, etc.

The curable resin composition may be cured by first combining the unsaturated polyester resin, the promoter system, optionally the monomer composition and/or the rubber modifier and any other components except for the initiator. The initiator may be combined with the remainder of the curable resin composition to initiate the polymerization of the unsaturated polyester resin. Thereafter, if desired, the curable composition is formed into a desired shape or brought into contact with a reinforcing structure such as those mentioned previously. The composition is then allowed to cure. In one embodiment, the curable resin composition cures at least substantially isotropically, thus reducing internal stresses in the cured resin which may otherwise lead to cracking, distortions, etc. In one embodiment, the curable resin composition cures isotropically so that the resulting cured resin does not include any cracks.

As mentioned previously, the peak exotherm of the curable resin composition may be between about 200° F. to about 360° F. Desirably, the peak exotherm is at least about 240° F., 260° F., or, desirably, 295° F. Also, the peak exotherm may be no more than 400° F., 355° F., or, desirably, 300° F. In one embodiment, the curable resin composition cures in at least 2 minutes, desirably, at least 5 minutes, or, suitably, at least 15 minutes. The curable resin may cure in no more than 60 minutes, desirably, no more than 30 minutes, or, suitably, no more than 20, 25, or 30 minutes. The cured resins have a heat distortion temperature which is at least about 158° F., desirably, at least about 194° F., or, suitably, at least about 239° F.

As mentioned previously, it is desirable to have two distinct crystallographic phases. One phase characterized by the unsaturated polyester resin and the other phase characterized by the rubber modifier (i.e., oligomer). Therefore, dynamical mechanical analysis will reveal two distinct Tgs. Using Stoke's law the shifted average glass transition temperature from the original unsaturated polyester resin my be measured. This shifted average glass transition temperature will be close to the in mold (peak) temperature during the final stage of polymerization (60% polymer conversion).

The cured resin may be any suitable thickness and may be prepared so that there are no visible cracks in the cured resin. For example, the cured resin may be any suitable thickness from about 5 mils to 5 inches or about 7 mils to 3 inches. The cured resin may not have any visible cracks when viewed by the naked eye. Also, the cured resin may be reinforced using randomly oriented fibrous material such as fiberglass. For example, the cured resin may use two or more differing lengths of fibrous material to reinforce the cured resin. The reinforced cured resin may have properties that prevent it from cracking and/or shattering when force is applied. The reinforced cured resin may be used in any suitable applications such as military applications, medical devices, etc.

The cured resin may be used as an interface between a drive ring and a composite mixing drum of the type disclosed in International Patent Application Serial No. PCT/US03/025438, filed on Aug. 15, 2003, the contents of which are incorporated by reference herein in their entirety.

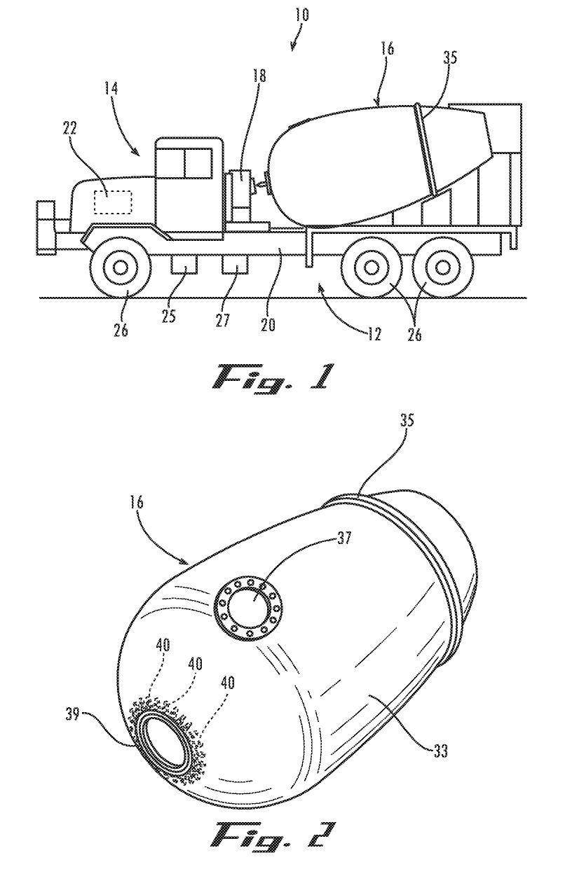

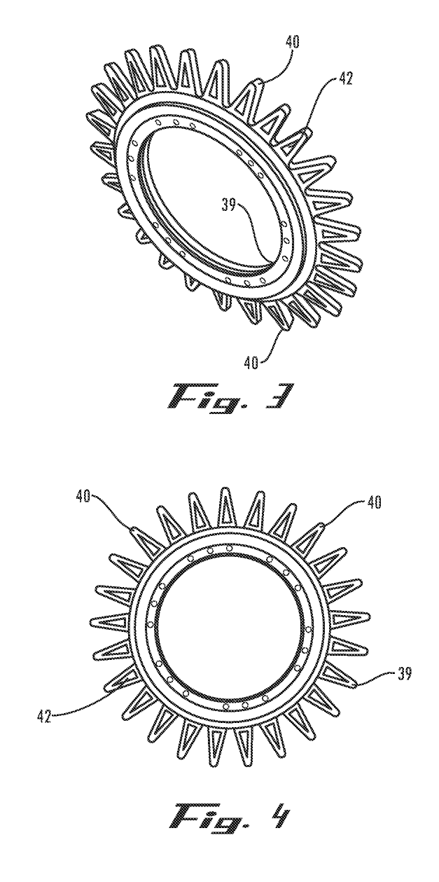

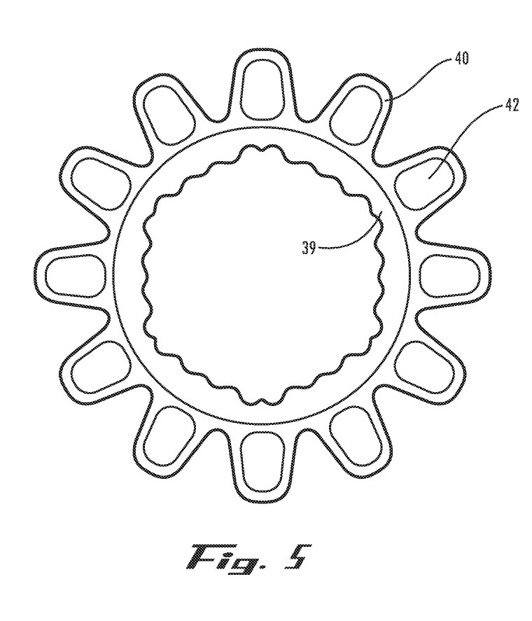

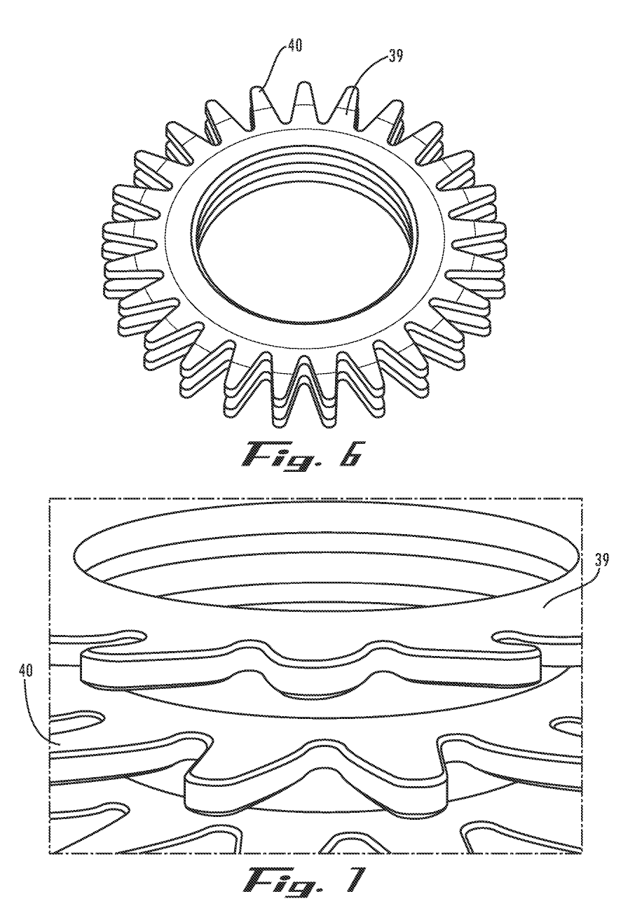

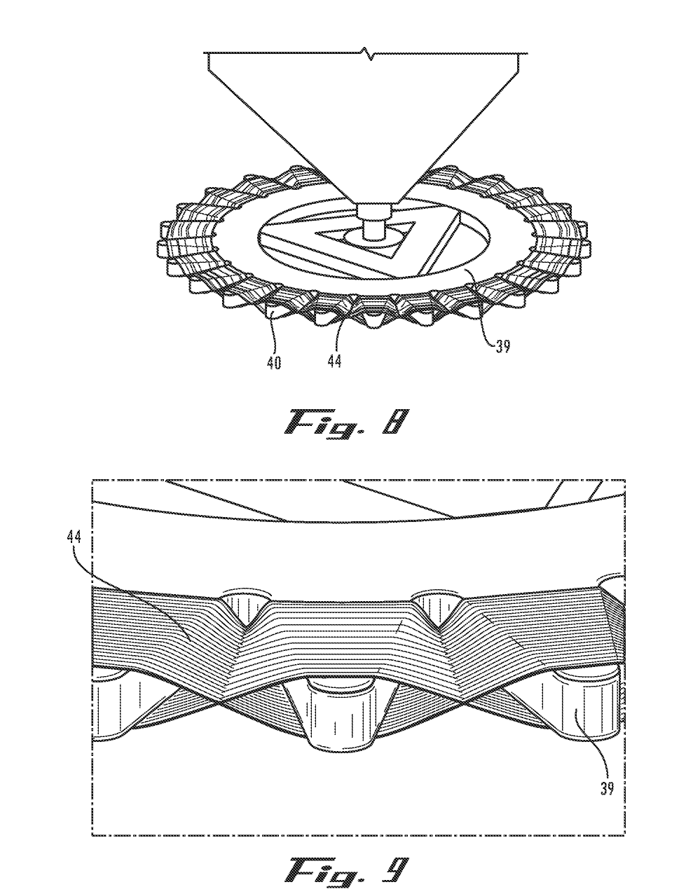

Referring to FIGS. 1-10, one application for the curable resin composition may be for use with a concrete vehicle 10, shown in FIG. 1. Although this example of the use of the curable resin composition is described in the context of the concrete vehicle 10, it should be understood that the concepts described herein may be used in a variety of settings and situations as would be recognized by those of ordinary skill in the art.

The concrete vehicle 10 includes a chassis 12, a cab region 14, a mixing drum 16, and a mixing drum drivetrain 18. Chassis 12 includes a frame 20, a power source 22, and wheels 26. Frame 20 provides mixing truck 10 with the structural support and rigidity needed to carry heavy loads of concrete. Power source 22 is coupled to frame 20 and generally comprises a source of rotational mechanical energy which is derived from a stored energy source. Examples include, but are not limited to, an internal combustion gas-powered engine, a diesel engine, turbines, fuel cell driven motors, an electric motor or any other type of motor capable of providing mechanical energy.

It should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

As shown in FIG. 2, the mixing drum 16 includes a barrel 33, a drive ring or daisy wheel 39, hatch cover assembly 37, and a roller ring 35. The drive ring 39 is used to transfer motion from the mixing drum drivetrain 18 (e.g., a rotating shaft, etc.) to the mixing drum 16. In one embodiment, the drive ring 39 may be made of metal and include a plurality of teeth 40. As shown in FIGS. 3-5, the drive ring 39 may include indentations 42 in the teeth 40.

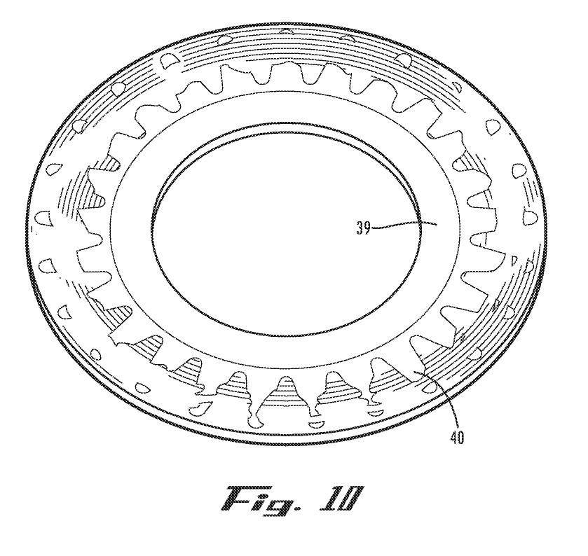

The curable resin composition described herein may be used to couple the drive ring 39 to the barrel 33, which may be made from a composite material, in the following manner. Referring to FIGS. 6-7, the drive ring 39 includes 25 teeth or spokes 40 and is about 1 inch thick. The first step in the process is to scrape or otherwise remove the scale from the drive ring 39 and then clean it in a suitable solvent such as acetone. Referring to FIGS. 8-9, a reinforcing structure, fiber, or filament 44 is wound in an over and under pattern through the teeth 40 of the drive ring 39. The rovings are wound to within 0.5 inches of the end of the teeth 44. The reinforcing fiber 44 may be any fiber which is capable of imparting greater strength to the drive ring 39, particularly after the resin has cured. In one embodiment, the reinforcing fiber comprises Hybon 2022 available from Pittsburgh Paint and Glass (PPG).

The curable resin composition is applied to the drive ring 39 using a vacuum assisted resin transfer molding machine (RTM) known by the trade name Spartan II which is manufactured by Glas Craft of Indianapolis, Ind. The RTM machine includes an INDY mixer gun for mixing and dispensing the curable resin composition. It should be appreciated that any suitable molding, laminating, etc. machine may be used to apply the curable resin composition. The initiator is directly mixed with the remainder of the curable resin composition as it is being injected into the mold. The parameters of the RTM machine were set as follows: (1) injection pressure—30 psi, (2) accu pressure—off, (3) resin temperature—79° F., (4) mold temperature—top: 100° F.—bottom: 100° F., and (5) initiator level and type—1.5% Luperox DHD-9 available from Atofina. The curable resin composition is injected so that it fills in the voids between the teeth 40 of the drive ring 39. Also, for the embodiments shown in FIGS. 3-5, the indentations 42 may be used to provide additional areas where the curable resin composition can interface with the drive ring 39. FIG. 10 shows the drive ring 39 after the resin has cured. The drive ring 39 having the cured resin is then attached to the mixing drum 16 using VE spandrel putty which is available from Valspar Composites. Once the drive ring 39 is in place, it is ready to be used as a transfer medium to transfer the rotary motion of a shaft on the mixing drum powertrain 18 to the mixing drum 16.

### EXAMPLES

The following examples are provided by way of illustration and are not intended to limit the scope of the claims. All percentages and parts are by weight unless otherwise noted. The materials shown in Table 1 were used in the examples and were supplied by the suppliers shown.

TABLE 1

| Material | Supplier |
|---|---|
| Polyester based material A | Ashland |
| | (Hetron LB 6505-057A) |
| Polyvinyl acetate (PVAc) based material B | Union Carbide (Neulon L) |
| Polybutadiene based material C | Noveon |
| | (Hycar ETBN 1300X40) |
| Polyol based material D | Era Polymers (CMD90A) |
| Dipropylene glycol based material E | Velsicol (Benzoflex 9-88) |
| N,N-dimethylacetoacetamide (DMAA) | Puritan Products |
| Copper naphthenate (CuNap) | Merichem |
| Methyl ethyl ketone peroxide (MEKP) | Atofina (Luperox DHD-9) |
| Benzoate material (Benzoate esters) | Velsicol (Benzoflex 9-88 SG) |

The compositions of the base polyester resin, PVAc component, and polybutadiene component are shown in Table 2-Table 4 below.

TABLE 2
Polyester based material A

| Ingredient | wt % |
|---|---|
| Polyester based resin | 60.0-64.0 |
| Styrene | 36.0 |
| Methacrylic acid | 1.0-3.0 |
| Cobalt compounds | 0.2 |
| % Shrinkage | 1.98% |

TABLE 3
Polyvinyl acetate based material B

| Ingredient | wt % |
|---|---|
| Styrene | 40.6 |
| Polyvinyl acetate polymeric material | 24.0-28.0 |
| Epoxidized 2-ethylhexyl tallate | 10.0-14.0 |
| Methyl methacrylate | 11.8 |
| Divinylbenzene | 4.0-8.0 |
| Dimethyl methylphosphonate | 1.0-3.0 |
| Ethylethenyl benzene | 1.0-3.0 |
| Vinyl acetate | 0.5 |

TABLE 4
Polybutadiene based material C

| Ingredient | wt % |
|---|---|
| Styrene | 50 |
| Epoxy terminated butadiene-acrylonitrile | 50 |
| copolymer | |

### Example 1

Curable resins having the compositions shown in Table 5 were prepared using the following procedures. Samples 1-5 were prepared by adding DMAA and copper naphthenate to the polyester based material A so that the resulting composition had the amount of DMAA and copper naphthenate specified in Table 5. Thus, the amount of DMAA and/or copper naphthenate shown in Table 5 is based on the total amount of polyester based material A, DMAA, and copper naphthenate (i.e., without regard to the amount of rubber modifiers such as PVAc material B, polybutadiene material C, polyol material D, or benzoate material). For situations where a large amount of curable resin was prepared (e.g., a 55 gallon barrel), a master batch was prepared by adding the amount of DMAA and/or copper naphthenate specified in Table 5 to make the final curable resin to 2 kg of the polyester based material A. The master batch was mixed using a cutting mixer blade (Cowles blade) for approximately 3-5 minutes. The master batch was added back into the larger amount of polyester based material A and mixed using a 4 paddle air mixer (paddles were manufactured by Drum Mates of Lumberton, N.J. and the air mixer was manufactured by Neptune of Lansdale, Pa.) for 2 hours.

Samples 6-16 were prepared in a similar manner to samples 1-5. However, in these samples, the amount of rubber modifier (i.e., PVAc based material B, polybutadiene based material C, polyol based material D, or dipropylene glycol based material E) was added to the polyester based material A—DMAA—copper naphthenate composition while the master batch having the DMAA and copper naphthenate was being prepared. After adding the materials which included the rubber modifier, the master batch was added back and the curable resin composition was mixed as described above.

TABLE 5

| | Polyester | PVAc | Polybutadiene | Polyol | | | |
|---|---|---|---|---|---|---|---|
| | Material A | material | material C | material D | Benzoate | DMAA | CuNap |
| Sample | (%) | B(%) | (%) | (%) | material (%) | (ppm*) | (ppm*) |
| 1 | 100 | — | — | — | — | — | 150 |
| 2 | 100 | — | — | — | — | 1000 | 150 |
| 3 | 100 | — | — | — | — | 200 | 150 |
| 4 | 100 | — | — | — | — | 1000 | 500 |
| 5 | 100 | — | — | — | — | 1200 | 400 |
| 6 | 80 | — | — | 20 | — | 1200 | 400 |
| 7 | 94 | — | — | 6 | — | 1200 | 400 |
| 8 | 94 | — | — | 6 | — | 1200 | 450 |
| 9 | 95 | — | — | 5 | — | 1200 | 300 |
| 10 | 97 | — | — | 3 | — | 1200 | 3 |
| 11 | 97 | — | — | — | 3 | 1200 | 350 |
| 12 | 85 | — | — | 15 | — | 1200 | 350 |
| 13 | 94 | — | — | 6 | — | 2400 | 400 |
| 14 | 85 | 15 | — | — | — | 2400 | 300 |
| 15 | 90 | — | 10 | — | — | 2400 | 300 |
| 16 | 90 | 10 | — | — | — | 1800 | 300 |

*ppm based on the total amount of base polyester resin, DMAA, and CuNap.

Table 6 shows the gel time, peak exotherm, and cure time for samples 1-16.

TABLE 6

| Sample | Gel Time | Peak Exotherm (° F.) | Cure Time |
|---|---|---|---|
| 1 | 25 m 39 s | 301.7 | 36 m 18 s |
| 2 | 14 m 12 s | 308.5 | 22 m 21 s |
| 3 | 20 m 11 s | 302.2 | 31 m 23 s |
| 4 | 16 m 24 s | 247.5 | 33 m 57 s |
| 5 | 16 m 30 s | 285.3 | 31 m 53 s |
| 6 | 22 m 3 s | 221.3 | 35 m 38 s |
| 7 | 18 m 41 s | 240.6 | 31 m 25 s |
| 8 | 12 m 25 s | 225.0 | 18 m 18 s |
| 9 | 14 m 46 s | 270.2 | 26 m 31 s |
| 10 | 11 m 39 s | 265.0 | 17 m 26 s |
| 11 | 10 m 42 s | 265.0 | 15 m 45 s |
| 12 | 10 m 54 s | 256.0 | 16 m 30 s |
| 13 | 13 m 23 s | 271.0 | 24 m 26 s |
| 14 | 10 m 25 s | 270.0 | 16 m 16 s |
| 15 | 9 m 50 s | 286.0 | 14 m 36 s |
| 16 | 14 m 47 s | 291.3 | 22 m 20 s |

### Example 2

The percent shrinkage of sample 16 was measured to be approximately 1.59%. Although cured resins prepared according to samples 1-15 exhibited some degree of cracking, these samples are still useful for at least the concrete drive ring application discussed previously. The cured resin prepared according to sample 16 did not exhibit any degree of cracking, and, thus, was considered the most resilient, strong, and useful of the samples that were prepared.

### Example 3

In this example, a number of reinforced cured resin plaques were prepared and tested for impact resistance. The reinforced cured resin plaques were reinforced using milled fibers. The reinforced cured resin plaques included 65 wt % of the resin having the composition shown in Table 7, 30 wt % of 470 micron length glass fiber (Microglass 6608, Fibertec), and 6 wt % of 150 micron length glass fiber (Microglass 9007D, Fibertec). Two different lengths of glass fibers were used to prevent the fibers from aligning during the curing process and warping the reinforced cured resin.

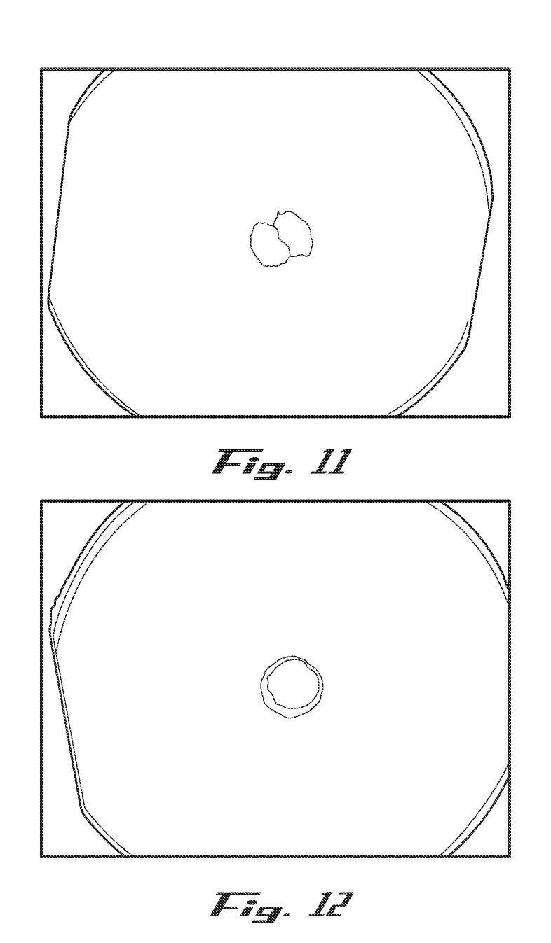

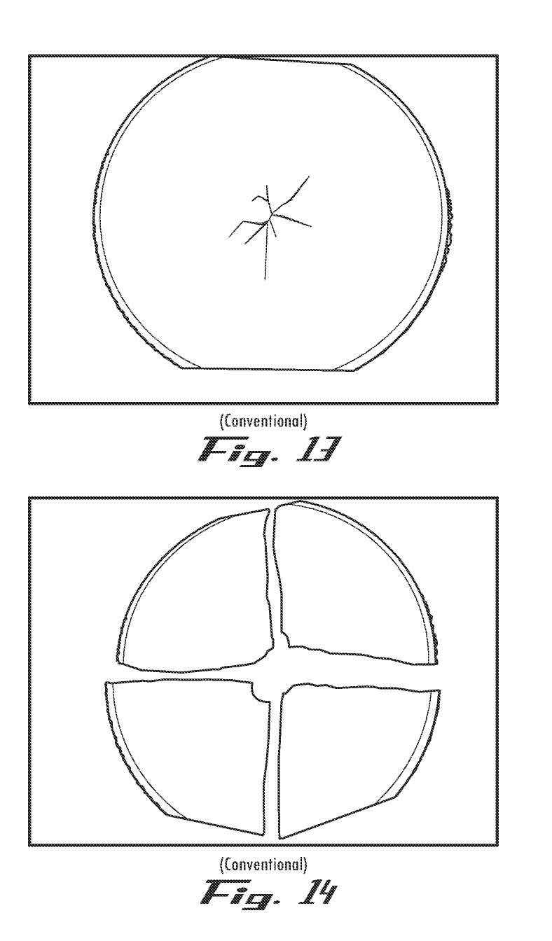

The reinforced cured resin plaques ranged in thickness from 0.18 inches to 0.20 inches. The plaques were tested using an impactor at forces up to about 32 J. The plaques showed cracks when a force above 0.23 J was applied. However, as shown in FIG. 11, the cracks were contained to the area where the force was applied. The cracks did not propagate towards the edges of the plaques. Any force about 21 J put a hole completely through the plaque in the area where the impactor was applied as shown in FIG. 12. However, there were still no cracks outside of the area where the force was applied. As a contrast, FIGS. 12 and 13 show similar force tests for plaques prepared using Valspar hand applied VE (vinyl ester) spandrel putty (e.g., product #5787700248VE). Forces between 0.5 J and 1.4 J resulted in cracks that propagated outward in a star pattern as shown in FIG. 12. Forces about 1.4 J caused the Valspar plaque to fail completely as shown in FIG. 13.

TABLE 7

| | Composition of Resin in |
|---|---|
| | Example 3 |
| Component | (%) |
| Polyester based material A | 84.64 |
| PVAc based material B | 9.42 |
| Dipropylene Glycol based material E | 0.99 |
| Methanol | 0.50 |
| Fumed Silica (Aerosil) | 1.57 |
| trimethylopropane triacrylate (SR-351) | 1.73 |
| DMAA | 0.70 |
| Defoamer (Byk A-500) | 0.15 |
| Cobalt Octoate | 0.10 |
| 1% CuNap Solution | 0.20 |

As used herein, spatial or directional terms, such as “left,” “right,” “front,” “back,” and the like, relate to the subject matter as it is shown in the drawing Figures. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive, that is “or” when it appears alone shall mean both “and” and “or.” Likewise, as used herein, the term “and/or” shall also be interpreted to be inclusive in that the term shall mean both “and” and “or.” In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification are understood as modified in all instances by the term “about.” At the very least, and not as an attempt to limit the application of the doctrine of equivalents to the claims, each numerical parameter recited in the specification or claims which is modified by the term “about” should at least be construed in light of the number of recited significant digits and by applying ordinary rounding techniques. Moreover, all ranges disclosed herein are to be understood to encompass any and all subranges subsumed therein. For example, a stated range of 1 to 10 should be considered to include any and all subranges between and inclusive of the minimum value of 1 and the maximum value of 10; that is, all subranges beginning with a minimum value of 1 or more and ending with a maximum value of 10 or less (e.g., 5.5 to 10).

1. A curable resin composition comprises:
an unsaturated polyester resin;
a rubber modifier;
N,N-dimethylacetoacetamide; and
an organic copper salt.

2. The curable resin composition of claim 1 wherein the composition comprises about 2 ppm to about 1000 ppm of the organic copper salt based on the total weight of the composition.

3. The curable resin composition of claim 1 wherein the composition comprises about 100 ppm to about 600 ppm of the organic copper salt based on the total weight of the composition.

4. The curable resin composition of claim 1 wherein the composition comprises about 500 ppm to about 4000 ppm of the N,N-dimethylacetoacetamide.

5. The curable resin composition of claim 1 wherein the rubber modifier comprises polyvinyl acetate based oligomers.

6. The curable resin composition of claim 1 wherein the composition comprises an initiator.

7. The curable resin composition of claim 6 wherein the initiator is a peroxide.

8. The curable resin composition of claim 1 wherein the composition comprises an organic cobalt salt, an organic vanadium salt, or mixtures thereof.

9. The curable resin composition of claim 1 wherein the rubber modifier comprises polar oligomers.

10. The curable resin composition of claim 1 wherein the rubber modifier comprises polyvinyl acetate based oligomers, polyvinyl alcohol based oligomers, or polar functionalized SIS, SBS, or polybutadiene.

11. The curable resin composition of claim 1 wherein the organic copper salt is a copper salt of a carboxylic acid having 5 to 20 carbon atoms.

12. A curable resin composition comprises:
an unsaturated polyester resin;
a first compound having the formula: 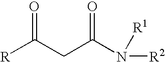
wherein R, R¹, R² are alkyl or aralkyl;
a rubber modifier; and
an organic copper salt.

13. The curable resin composition of claim 12 wherein the organic copper salt comprises copper naphthenate.

14. The curable resin composition of claim 12 wherein the rubber modifier comprises a polar oligomer.

15. The curable resin composition of claim 12 wherein the first compound is N,N-dimethylacetoacetamide.

16. The curable resin composition of claim 12 comprising randomly oriented fibrous material.

17. The curable resin composition of claim 16 wherein the randomly oriented fibrous material comprises glass fiber material having at least two different lengths.

18. A process for preparing a cured resin from a curable resin composition comprising:
combining an unsaturated polyester resin, N,N-dimethylacetoacetamide, a rubber modifier; and an organic copper salt.

19. The process of claim 18 wherein a cure time for the curable resin composition is between 5 and 20 minutes.

20. The process of claim 18 wherein a peak exotherm of the process is between about 275° F. and 325° F.
